(19) United States
(12) Patent Application Publication
(10) Pub. No.: US 2026/0336608 A1
(43) Pub. Date: Oct. 29, 2026

(54) ADAPTIVE DECELERATION SYSTEM AND METHOD

(71) Applicant: Toyota Material Handling, Inc., Columbus, IN (US)

(72) Inventors: Sumit Ojas Narang, Columbus, IN (US); Kevin Partridge, Columbus, IN (US); Maitry Harshel Naik, Columbus, IN (US)

(21) Appl. No.: 19/662,489

(22) Filed: Apr. 29, 2026

Related U.S. Application Data
(60) Provisional application No. 63/796,735, filed on Apr. 29, 2025.

(51) Int. Cl. B60W 30/09; B60W 30/18

(52) U.S. Cl. CPC B60W 30/09; B60W 30/18127; B60W 2300/12; B60W 2520/10; B60W 2530/10; B60W 2530/201; B60W 2554/802

(57) ABSTRACT

A material handling vehicle having an electronic control unit, a perception system, a carriage assembly, a height sensor for sensing a height of the carriage assembly, a speedometer for determining a traveling speed of the material handling vehicle, and a sensor for sensing a load weight of a load carried by the carriage assembly is provided. The electronic control unit is configured to limit vehicle deceleration to a deceleration threshold value based on the height of the carriage assembly, a traveling speed of the material handling vehicle, and the load weight of the load when the perception system detects an obstacle at a distance from the material handling vehicle.

### CROSS REFERENCE TO RELATED APPLICATION

This application claims priority to U.S. Provisional Patent Application No. 63/796,735, filed Apr. 29, 2025, the entire disclosure of which is incorporated by reference herein.

### BACKGROUND

Material handling vehicle operators must maintain vigilance to safely operate a material handling vehicle in a warehouse. In conventional warehouse environments, material handling vehicle operators must be careful to avoid obstacles such as warehouse employees, other material handling vehicles, and objects throughout the warehouse environment. At the same time, material handling vehicle operators must maneuver the material handling vehicle carefully to avoid tipping the material handling vehicle or inadvertently dropping a load carried by the material handling vehicle. Conventional electric material handling vehicles use a combination of regenerative braking and service braking to slow the vehicle down. However, operators may miscalculate the distance of an obstacle or lose track of their speed and fork height, leading to vehicle damages and accidents. Therefore, there exists a need for a more effective material handling vehicle deceleration system and method.

### SUMMARY

This disclosure relates to an adaptive deceleration limiting system and method for a material handling vehicle. More specifically, this disclosure relates to material handling vehicles equipped with an adaptive deceleration system configured to apply deceleration limits based on multiple inputs.

Some embodiments provide a material handling vehicle having an electronic control unit, a perception system, a carriage assembly, a height sensor for sensing a height of the carriage assembly, a speedometer for determining a traveling speed of the material handling vehicle, and a sensor for sensing a load weight of a load carried by the carriage assembly. The electronic control unit is configured to limit vehicle deceleration to a deceleration threshold value based on the height of the carriage assembly, a traveling speed of the material handling vehicle, and the load weight of the load when the perception system detects an obstacle at a distance from the material handling vehicle.

In some forms, the electronic control unit limits vehicle deceleration when the height of the carriage assembly is above a height threshold value, the traveling speed of the material handling vehicle is above a speed threshold value, the load weight is above a load weight threshold value, and the distance is below a distance threshold value. In some forms, the deceleration threshold value is selected from a plurality of deceleration values based on the load weight. In some forms, the plurality of deceleration values correspond to a plurality of load weight threshold values. In some forms, the material handling vehicle includes a feedback device provided in the form of one or both of an audio device or an illumination device. In some forms, the audio device is provided in the form of a horn and the illumination device is provided in the form of a lamp. In some forms, vehicle deceleration is limited by way of a command from the electronic control unit to a traction motor to modify a regenerative braking function.

Some embodiments provide a method for adaptive deceleration of a material handling vehicle including the steps of determining a height associated with a carriage assembly of the material handling vehicle, determining a traveling speed of the material handling vehicle, determining a load weight of a load carried by the material handling vehicle, detecting an obstacle at a distance from the material handling vehicle, and limiting deceleration of the material handling vehicle based on the height, the traveling speed, and the load weight when the obstacle is detected at the distance.

In some forms, deceleration of the material handling vehicle is limited only when the height is above a height threshold value, the traveling speed is above a traveling speed threshold, the load weight is above a load weight threshold, and the distance is below a distance threshold.

Some embodiments provide a material handling vehicle that includes a motor, an object sensor, a load sensor, a speed sensor, and a processor and memory. The processor and memory are configured to detect an object based on signals from the object sensor, determine a distance to the object based on signals from the object sensor, determine a weight of a load carried by the material handling vehicle based on signals from the load sensor, determine a speed of the material handling vehicle based on signals from the speed sensor, and issue a deceleration limit command to the motor based on the distance, the weight, and the speed.

In some forms, the processor and memory are configured to determine a relative speed between the material handling vehicle and the object based on signals from the object sensor and the speed sensor.

In some forms, the deceleration limit command modifies a regenerative braking function of the motor.

In some forms, the object sensor includes one or more of a laser scanner, a proximity sensor, radar, lidar, an optical sensor, an infrared sensor, and a camera.

In some forms, the processor and memory are configured to detect and determine distances from the object sensor to multiple objects simultaneously.

In some forms, the processor and memory are configured to issue the deceleration limit command to the motor based on a determination as to whether the speed exceeds a speed threshold, and the weight exceeds a weight threshold.

In some forms, the processor and memory are configured to issue the deceleration limit command at one of a plurality of limit levels according to a corresponding plurality of weight thresholds. In some forms, when the weight is between a first weight threshold and a second weight threshold greater than the first weight threshold, the processor and memory are configured to issue the deceleration limit command at the limit level corresponding to the first weight threshold.

In some forms, deceleration limit values corresponding to the deceleration limit command decrease as the weight thresholds increase.

In some forms, the material handling vehicle also has a carriage assembly and a height sensor configured to sense a height of the carriage assembly, and the processor and memory are configured to issue the deceleration limit command to the motor further based on the sensed height of the carriage assembly.

In some forms, the deceleration limit command includes one or more of disabling and ignoring signals from an accelerator pedal.

### BRIEF DESCRIPTION OF THE DRAWINGS

FIG. 1 is a right-side elevational view of a material handling vehicle according to one embodiment;

FIG. 2 is a block diagram of system components associated with a perception system according to disclosed embodiments;

FIG. 3 is a flow diagram of a method of adaptive deceleration according to disclosed embodiments; and

FIG. 4 is a graph depicting a relationship between load weight threshold values and deceleration limit levels.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded with the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings, but can also refer to communicative, electrical, or fluidic couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

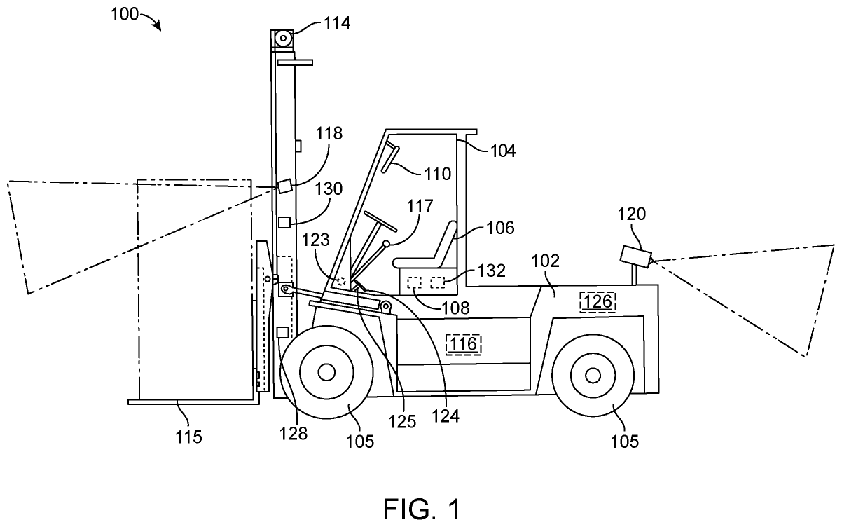

FIG. 1 illustrates a material handling vehicle 100 according to an embodiment of the disclosure. Specifically, a counterbalance-type forklift truck is illustrated, although the systems and processes described herein can be applied to other types of material handling vehicles. The material handling vehicle 100 can include a body 102, an operator cab 104, two or more wheels 105, a driver's seat 106, an electronic control unit 108, and a display module 110. The material handling vehicle 100 further includes a mast 114, a carriage assembly 115, a traction motor 116, one or more gear shift levers 117 (e.g., for controlling the direction and/or speed of the material handling vehicle 100), one or more front-facing sensors 118, one or more rear-facing sensors 120, and/or one or more feedback devices 123. The material handling vehicle 100 includes an accelerator pedal 124 (or a hand controller in steer-by-wire systems) for activating the traction motor 116 and a braking pedal 125 for activating a service brake. In some forms, the service brake is provided in the form of a hydraulic braking system.

The traction motor 116, in some embodiments, can be electrically powered by a battery 126 in instances where the material handling vehicle 100 is provided in the form of a battery electric vehicle (BEV). The mast 114, the carriage assembly 115, the traction motor 116, and the one or more gear shift levers 117 can be electrically and/or communicatively coupled to the electronic control unit 108. The electronic control unit 108 can also include a memory and a processor for storing computer-executable code and executing the computer-executable code, respectively. Accordingly, the electronic control unit 108 may be designed to, or otherwise configured to, control various functions of the material handling vehicle 100. For example, the electronic control unit 108 can control acceleration, deceleration (via regenerative braking), braking, and steering of the material handling vehicle 100. The electronic control unit 108 may also be able to change the gear that the material handling vehicle 100 is operating in, switch between forward and reverse directions, and change the heading of the material handling vehicle 100.

In some instances, each of the front-facing sensor 118 and the rear-facing sensor 120 can be provided in the form of a laser scanner, a proximity sensor, radar, lidar, an optical sensor (such as infrared sensors), or a camera, specifically a stereo camera unit. In some forms, the one or more feedback devices 123 can be configured to alert the operator by auditory, visual, and/or tactile means provided in the form of buzzers, sirens, horns, announcements, lights, lamps, strobes, images, vibrations, and/or pulsations. The front-facing sensor 118 may be positioned to sense the environment in front of the material handling vehicle 100. The front-facing sensor 118 may be attached to the mast 114 or to another portion of the front end of the material handling vehicle 100. Similarly, the rear-facing sensor 120 may be positioned to sense the environment behind the material handling vehicle 100. The rear-facing sensor 120 may be positioned on or adjacent the rear end of the body 102, for example. The feedback devices 123 can, in some instances, display data or an alert on the display module 110.

The material handling vehicle further includes a load weight sensor 128, a height sensor 130, and a speedometer 132, all of which are electrically and/or communicatively coupled to the electronic control unit 108 via a wired or wireless configuration. In some forms, the load weight sensor 128 is provided in the form of a pressure sensor configured to measure the pressure in the hydraulic lift cylinder for the carriage assembly 115. Here, the electronic control unit 108 can determine a load weight of a load carried by the carriage assembly 115 based on signals from the load weight sensor 128. The height sensor 130 can be provided in the form of a height switch configured to output a binary signal as to whether the carriage assembly 115 or a specific component thereof (fork tines, back rest, etc.) is raised or lowered above or below a particular height. In some forms, the height sensor 130 is provided in the form of a string potentiometer.

In some forms, the speedometer 132 includes a motor RPM sensor, and the motor RPM sensor sends signals including motor RPM values to the electronic control unit 108 and/or the display module 110. The electronic control unit 108 and/or a processor of the display module 110 then calculates the speed of the material handling vehicle 100 using a tire radius value such as a dynamic tire radius value or a static tire radius value. The dynamic tire radius value can, for example, vary based on the load carried by the carriage assembly 115. The static tire radius value can, for example, be a tire radius value that falls between a no-load tire radius and a full-load tire radius such that the calculated speed has no more than a certain percentage of error, such as about 7.5% error, regardless of the weight of the load. In some forms, the static tire radius value is used for displaying speed to the user as part of a digital speedometer on the display, whereas the dynamic tire radius value is used as an actual speed for other system calculations that require a more accurate speed measurement.

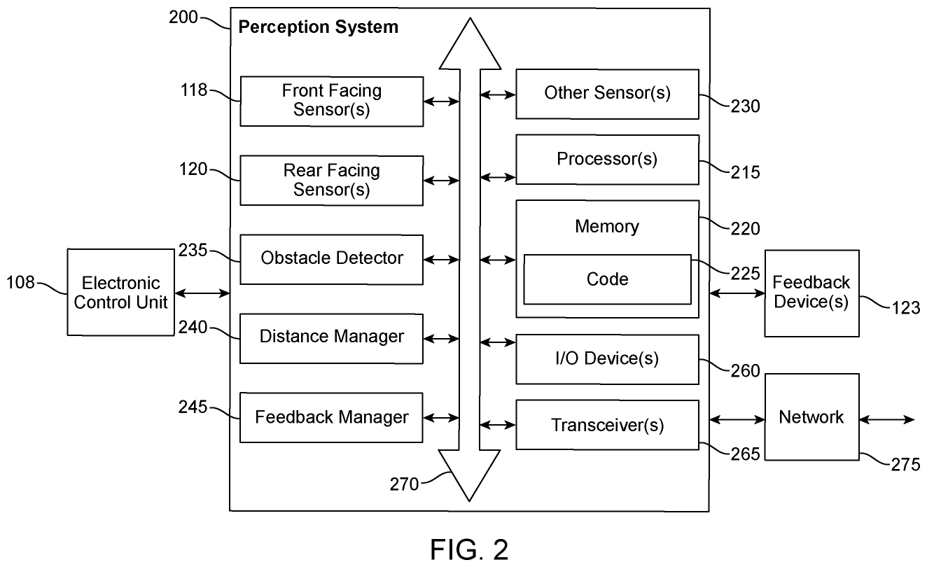

FIG. 2 illustrates a block diagram of system components associated with a perception system 200 of the material handling vehicle 100. The perception system 200 can process sensor data to identify one or more obstacles within the vicinity of the material handling vehicle 100. The perception system 200 can also initiate one or more feedback operations based on detecting obstacles and one or more additional factors. In some examples, some components of the perception system 200 may be located externally to the material handling vehicle 100.

The perception system 200 may include the front-facing sensor 118, the rear-facing sensor 120, at least one processor 215, a memory 220 configured to store computer-executable code 225, one or more other sensors 230, an obstacle detector 235, a distance manager 240, a feedback manager 245, at least one input and output (I/O) device 260, and at least one transceiver 265. These components may be in electronic communication or otherwise connected (e.g., operatively, communicatively, functionally, electronically, electrically) via one or more buses (e.g., a bus 270).

The perception system 200 may be capable of wireless or wired communication with one or more networks 275 over at least one communication link via the transceiver 265. The perception system 200 described herein may be able to communicate with various types of devices, such as Internet-of-Things (IoT) devices, as well as network entities associated with the one or more networks 275. In some examples, other IoT devices may act as nodes for the perception system 200 to provide information to the one or more networks 275 or to other material handling vehicles 100.

The processor 215 of the perception system 200 and/or the processor of the electronic control unit 108 may be provided in the form of one or more of any suitable processing devices or set of processing devices such as, but not limited to a microprocessor, a microcontroller-based platform, a suitable integrated circuit, one or more field programmable gate arrays (FPGAs), and/or one or more application-specific integrated circuits (ASICs). The processors are configured to execute non-transitory computer readable instructions, such as those instructions stored in the memory 220 of the perception system 200 or the memory of the electronic control unit 108.

In some forms, the processors may include multiple processors, the memories may include multiple memories, and the electronic control unit 108 may include multiple controllers including but not limited to a battery management system, a transmission control module, a brake control module, and a central control module. One or more of the multiple processors may be coupled with one or more of the multiple memories, which may, individually or collectively, be configured to perform various functions described herein. In some examples, the processor may be a component of a processing system, which may refer to a system (such as a series) of machines, circuitry (including, for example, one or both of processor circuitry (which may include the processor) and memory circuitry (which may include the memory)), or components, that receives or obtains inputs and processes the inputs to produce, generate, or obtain a set of outputs. The processing system may be configured to perform one or more of the functions described herein.

For example, the processor 215 of the perception system 200 or a processing system including the processor 215 of the perception system 200 and the processor of the electronic control unit 108 may be configured to, or configurable to, perform one or more of the functions described herein. Further, as described herein, being “configured to,” being “configurable to,” and being “operable to” may be used interchangeably and may be associated with a capability, when executing code (e.g., computer-executable code) stored in the memory or otherwise, to perform one or more of the functions described herein.

The front-facing sensor 118 and the rear-facing sensor 120 may sense various parameters of the environment surrounding the material handling vehicle 100, such as visual, auditory, or other environmental features. One or more of the front-facing sensors 118 or the rear-facing sensors 120 may also be configured to generate sensor data. The front-facing sensors 118 and the rear-facing sensors 120 may communicate the corresponding sensor data with the one or more processors 215 of the perception system 200. For example, the front-facing sensor 118 and the rear-facing sensor 120 may capture still or continuous images and provide the corresponding image data to the one or more processors 215 for analysis or display.

In some embodiments, the obstacle detector 235, the distance manager 240, and the feedback manager 245 can be provided in the form of computer-executable code stored in the memory 220 and executable by the processor 215. For example, the processor 215 may send one or more signals, such as control signals, to activate the at least one feedback device 123 or provide commands to the electronic control unit 108 based at least in part on an analysis performed on the sensor data from the front-facing sensor 118 or the rear-facing sensor 120.

As mentioned above, the electronic control unit 108 may be configured to control various functions of the material handling vehicle 100 such as acceleration, braking, steering, and gear changes of the material handling vehicle 100. Further, the electronic control unit 108 may perform any of these functions in response to receiving instructions from the perception system 200. The instructions may be in the form of one or more signals, for example.

The obstacle detector 235 may receive the captured sensor data from the front-facing sensor 118, the rear-facing sensor 120, or the other sensors 230, either directly from the sensors 118, 120, 230 or via another component of the perception system 200, such as the at least one processor 215. In some examples, the captured data may be image-based data, such as still images or video. The image-based data may be in the visible spectrum or in other portions of the radio frequency spectrum, such as infrared. The obstacle detector 235 may perform image processing techniques, such as computer vision techniques, on the captured data to identify one or more obstacles. Example obstacles may include pedestrians, animals, objects, other vehicles, warehouse goods, or other features of the environment.

The obstacle detector 235 may output one or more signals indicating that one or more obstacles have been identified. For each identified obstacle, the output may include information about the obstacle such as a type of obstacle, a timestamp for when the obstacle was detected, identifying information about the obstacle, a size of the obstacle, and the like. The output may be provided to any of the components of the perception system 200, such as the at least one processor 215, the memory 220, the distance manager 240, the feedback manager 245, and the like.

The distance manager 240 may then determine a distance between the material handling vehicle 100 and any obstacles identified by the obstacle detector 235. The distance manager 240 may receive sensor data, such as a GNSS or GPS location, proximity data, image data, or the like from the front-facing sensor 118, the rear-facing sensor 120, or the other sensors 230. The distance manager 240 may receive this data either directly from the sensors 118, 120, 230 or via another component of the perception system 200, such as the at least one processor 215. The distance manager 240 may determine a distance from the material handling vehicle 100 to each of the identified obstacles based on the sensor data. In some examples, the distance manager 240 may determine the distance using any suitable technique for measuring distance. Such techniques may include using radar, lidar, sonar information, infrared distance measurements, a map of the environment, image processing to determine distance to the obstacle, GNSS data, Radio Frequency Identification (RFID) tags, near-field communications, data from proximity sensors, stereo vision techniques, monocular vision with depth estimation, odometry techniques, and the like.

The distance may be a real-time distance or may be a predicted distance based on a certain time period. For example, the distance may be determined based on a predicted location of the material handling vehicle 100 and the obstacle when a predetermined duration has passed, such as 3 seconds. In other examples, other durations may be used. If there is more than one obstacle, the distance manager 240 may perform the distance measurements for each obstacle. The distance manager 240 may also apply techniques to determine if the distance may be changing based on motion of the obstacle and the material handling vehicle 100. For example, if the distance manager 240 determines that the obstacle is moving towards or away from the material handling vehicle 100, the distance manager 240 may adjust the determined distance based on the determined motion.

In other examples, the distance manager 240 may also determine a speed of the material handling vehicle 100. The distance manager 240 may determine a current speed or a predicted speed in a predetermined time period. In some examples, the current speed may be determined based on data from the speedometer 132 as communicated by the electronic control unit 108 to the perception system 200, accelerometer data, or any other types of data described herein. The predicted speed may be based on factors, including but not limited to, a history of the operator, an incline or decline of the direction the material handling vehicle 100 is heading, a current acceleration rate, a current deceleration rate, or the like. The distance manager 240 may also determine a relative speed between the material handling vehicle 100 and each detected obstacle.

The distance manager 240 can compare the speeds to one or more speed thresholds and the distance to one or more distance thresholds, in combination or separately, to determine if an obstacle qualifies as an in-range obstacle. The distance manager 240 can then output one or more signals indicating the presence of an in-range obstacle, which may require action by the vehicle 100. The output may be provided to any of the components of the perception system 200, such as the at least one processor 215, the memory 220, the obstacle detector 235, the feedback manager 245, and the like.

The feedback manager 245 may receive one or more signals regarding the in-range obstacles to determine what, if any, feedback operations may be taken. Accordingly, the feedback manager 245 may output one or more signals to activate the feedback device 123, generate a notification, and/or instruct the electronic control unit 108 to control the movement of the material handling vehicle 100 in response to a detected in-range obstacle. The feedback device 123 may receive instructions from the feedback manager 245 to activate the feedback device 123. The feedback device 123 may then perform the feedback operation suitable for the feedback device 123, such as sounding an alarm such as a horn, flashing lights, turning on a siren, turning on strobe lights, turning on other types of lights, providing haptic feedback, or performing other auditory, visual, tactile, or other sensory notifications. The feedback operation may be a notification provided in the form of various alarms that alert the operator of the material handling vehicle 100 or others proximate to the material handling vehicle 100 to the conditions of the surrounding environment. In some forms, the feedback operation may be generating a notification to transmit to a remote server or user device to alert a supervisor.

Additionally, or alternatively, the electronic control unit 108 may receive instructions from the feedback manager 245 to perform a feedback operation on the material handling vehicle 100 in response to a detected in-range obstacle. The feedback operation performed by the electronic control unit 108 can include providing limits to acceleration, deceleration, or speed, steering the vehicle, changing the heading, changing an operating gear, stopping the vehicle, and the like. In some forms, the feedback operation includes providing limits to, or commanding, a deceleration action provided by the regenerative braking function of the traction motor 116. Controlling the deceleration action can include limiting the magnitude of permitted deceleration via the regenerative braking function of the traction motor 116 when an accelerator pedal 124 is in a non-actuated position. In some forms, controlling the deceleration action includes disabling or ignoring signals from the accelerator pedal 124 when it is in an actuated position, and prioritizing the deceleration command for the regenerative braking function of the traction motor 116. Accordingly, regardless of the position of the accelerator pedal 124, the traction motor 116 will perform regenerative braking rather than acceleration.

In some forms, either or both of the perception system 200 and the feedback device 123 may be modular. For example, the perception system 200 may be removably connected with one or more components of the material handling vehicle 100. Likewise, the feedback device 123 may be modular. The perception system 200 or the feedback device 123 may be able to be retrofitted onto different types of material handling vehicles 100.

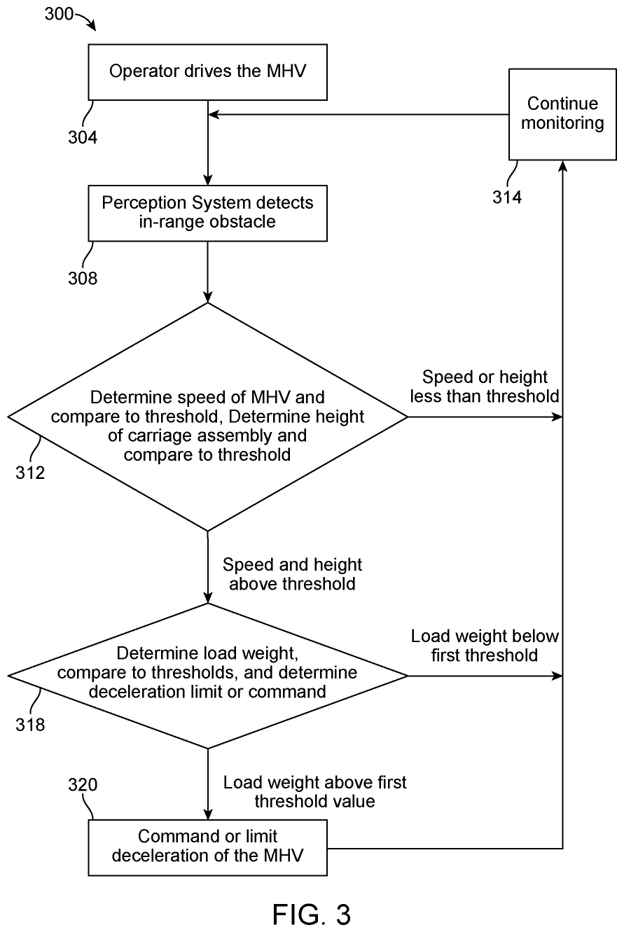

FIG. 3 illustrates a flow diagram of a method 300 of modifying the deceleration of the material handling vehicle 100 by way of an adaptive deceleration system. For example, the method 300 can include limiting deceleration of the material handling vehicle 100 in response to an obstacle detected by the perception system 200.

The method 300 begins at step 304 when the operator operates the material handling vehicle 100 about a warehouse or other environment. At step 308, the perception system 200 detects an in-range obstacle as described above with respect to FIG. 2. In response, the perception system 200 sends a signal to the electronic control unit 108 to communicate that an in-range obstacle has been detected and that limits to vehicle deceleration, or a deceleration command, may need to be communicated to the traction motor 116 to modify the regenerative braking function. At the same time, the perception system 200 can activate the feedback device, such as by providing an illumination of a lamp or an audible alert via a buzzer or horn. It is to be understood that instead of, or in addition to, deceleration limits, the in-range obstacle signal may command a speed limit or an acceleration limit.

After receiving the in-range obstacle signal from the perception system 200, the electronic control unit 108 checks certain vehicle parameters to confirm whether deceleration via the regenerative braking function should be modified. For example, at step 312, the electronic control unit 108 determines the traveling speed of the material handling vehicle via the speedometer 132 and/or the distance manager 240 of the perception system 200 and compares the traveling speed to a speed threshold value. In some forms, the speed threshold value is a first value when the material handling vehicle 100 is traveling forward and a second value different from the first value when the material handling vehicle 100 is traveling backward. Also at step 312, the electronic control unit 108 determines a height of the carriage assembly 115 via the height sensor 130 and compares the determined height to a height threshold value. If either the traveling speed is determined to be below the speed threshold value or the height of the carriage assembly 115 is determined to be below the height threshold value, the electronic control unit 108 will not modify vehicle deceleration and will continue monitoring for a signal from the perception system 200 regarding an in-range obstacle at step 314. If, however, the traveling speed is determined to be above the speed threshold value and the height of the carriage assembly 115 is determined to be above the height threshold value, the method proceeds to step 318.

At step 318, the electronic control unit 108 determines a load weight of a load being carried by the carriage assembly 115. To determine the next action, the electronic control unit 108 compares the determined load weight to one or more thresholds. If the load weight is between zero load weight and a first load weight threshold value, the electronic control unit 108 will not modify vehicle deceleration and will continue monitoring for a signal from the perception system 200 regarding an in-range obstacle at step 314. However, if the load weight is above the first load weight threshold value, the electronic control unit 108 will provide limits or commands to a deceleration action provided by the regenerative braking function of the traction motor 116. In some forms, the first load weight threshold value is such that any non-zero load weight value will trigger a deceleration limit to be applied to the traction motor 116.

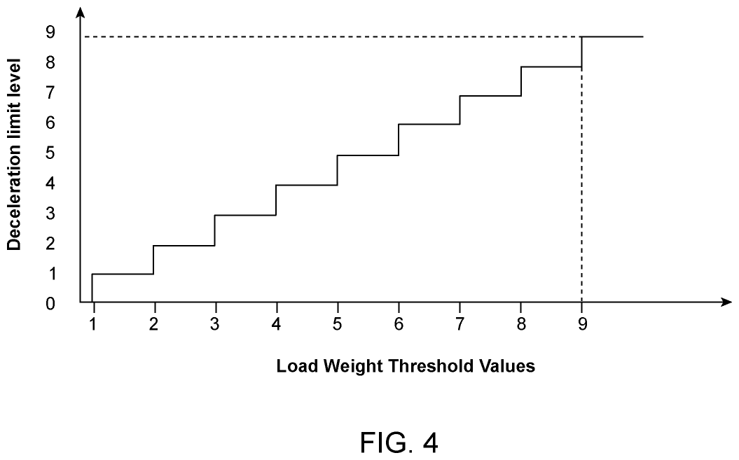

Referring to FIG. 4, in some forms, the electronic control unit 108 stores a table with a plurality of load weight threshold values and corresponding deceleration limits or commands. For example, the electronic control unit 108 can store nine load weight threshold values corresponding to nine deceleration limit levels, although other amounts of thresholds are contemplated. If the load weight is above the first load weight threshold value but below the second load weight threshold value, the electronic control unit 108 will provide a deceleration limit that corresponds to the level 1 deceleration limit. Similarly, if the load weight is above the second load weight threshold value but below the third load weight threshold value, the electronic control unit 108 will provide a deceleration limit that corresponds to the level 2 deceleration limit, and so on. Accordingly, the magnitude of the deceleration limit is dependent on the magnitude of the load weight.

Here, different models of material handling vehicle 100 have a different stability ratio values that are governed by ANSI. In some forms, the load weight threshold values and the deceleration limits are based on a particular vehicle's stability ratio. Accordingly, the load weight threshold values differ between vehicle models. For example, the load weight threshold values can range between about 1,750 lbs and about 17,500 lbs for one vehicle, and between about 300 lbs and about 3,000 lbs for another vehicle. Similarly, the deceleration limit values corresponding to each deceleration limit level will differ between vehicle models. For example, the level 1 deceleration limit can be 8 km/h, and the level 9 deceleration limit can be 1 km/h for one vehicle, and the level 1 deceleration limit can be 7 km/h, and the level 9 deceleration limit can be 2 km/h for another vehicle. Accordingly, the load weight threshold values and the deceleration limits can be tailored to the unique stability properties of each material handling vehicle 100. In some forms, because the deceleration limits apply to only the regenerative braking function of the traction motor 116, the operator can brake faster than the commanded limit by activating the service brakes with the braking pedal 125.

It should be understood that the type and number of traction motors 116 as well as the type and number of batteries 126 can also vary between each model of material handling vehicle 100. Accordingly, the maximum regenerative torque of the traction motor(s) 116 and the regenerative power limit of the battery(ies) 126 can vary between each model of material handling vehicle 100. Regardless of the deceleration limit or command provided by the electronic control unit 108 to the motor 116, the maximum regenerative torque of the traction motor(s) 116 and the regenerative power limit of the battery(ies) 126 might be dispositive as to the magnitude of deceleration provided by the regenerative braking function. For example, the electronic control unit 108 might set a deceleration limit for the regenerative braking function of 8 km/h, but if the traction motor 116 cannot provide enough torque to decelerate faster than 7 km/h, then the deceleration provided by the regenerative braking function is limited to 7 km/h. Further, the electronic control unit 108 might set a deceleration limit for the regenerative braking function of 8 km/h, but if the battery 126 does not have enough charge capacity to allow deceleration faster than 7 km/h, then the deceleration provided by the regenerative braking function is limited to 7 km/h.

In other embodiments, other configurations are possible. For example, those of skill in the art will recognize, according to the principles and concepts disclosed herein, that various combinations, sub-combinations, and substitutions of the components discussed above can provide appropriate control for a variety of different configurations of IoT devices, material handling vehicles, work machines, operator control systems, automotive vehicles, consumer electronics, and so on, for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded with the widest scope consistent with the principles and novel features disclosed herein.

What is claimed is:

1. A material handling vehicle comprising:
an electronic control unit;
a perception system;
a carriage assembly;
a height sensor for sensing a height of the carriage assembly;
a speedometer for determining a traveling speed of the material handling vehicle; and
a sensor for sensing a load weight of a load carried by the carriage assembly,
wherein the electronic control unit is configured to limit vehicle deceleration to a deceleration threshold value based on the height of the carriage assembly, the traveling speed of the material handling vehicle, and the load weight of the load when the perception system detects an obstacle at a distance from the material handling vehicle.

2. The material handling vehicle of claim 1, wherein the electronic control unit limits vehicle deceleration when the height of the carriage assembly is above a height threshold value, the traveling speed of the material handling vehicle is above a speed threshold value, the load weight is above a load weight threshold value, and the distance is below a distance threshold value.

3. The material handling vehicle of claim 2, wherein the deceleration threshold value is selected from a plurality of deceleration values based on the load weight.

4. The material handling vehicle of claim 3, wherein the plurality of deceleration values correspond to a plurality of load weight threshold values.

5. The material handling vehicle of claim 1, further comprising a feedback device provided in the form of one or both of an audio device or an illumination device.

6. The material handling vehicle of claim 5, wherein the audio device is provided in the form of a horn and the illumination device is provided in the form of a lamp.

7. The material handling vehicle of claim 1, wherein vehicle deceleration is limited by way of a command from the electronic control unit to a traction motor to modify a regenerative braking function.

8. A method for adaptive deceleration of a material handling vehicle, the method comprising:
determining a height associated with a carriage assembly of the material handling vehicle;
determining a traveling speed of the material handling vehicle;
determining a load weight of a load carried by the material handling vehicle;
detecting an obstacle at a distance from the material handling vehicle; and
limiting deceleration of the material handling vehicle based on the height, the traveling speed, and the load weight when the obstacle is detected at the distance.

9. The method of claim 8, wherein deceleration of the material handling vehicle is limited only when the height is above a height threshold value, the traveling speed is above a traveling speed threshold, the load weight is above a load weight threshold, and the distance is below a distance threshold.

10. A material handling vehicle comprising:
a motor;
an object sensor;
a load sensor;
a speed sensor; and
a processor and memory configured to
detect an object based on signals from the object sensor,
determine a distance to the object based on signals from the object sensor,
determine a weight of a load carried by the material handling vehicle based on signals from the load sensor,
determine a speed of the material handling vehicle based on signals from the speed sensor, and
issue a deceleration limit command to the motor based on the distance, the weight, and the speed.

11. The material handling vehicle of claim 10, wherein the processor and memory are configured to determine a relative speed between the material handling vehicle and the object based on signals from the object sensor and the speed sensor.

12. The material handling vehicle of claim 10, wherein the deceleration limit command modifies a regenerative braking function of the motor.

13. The material handling vehicle of claim 10, wherein the object sensor includes one or more of a laser scanner, a proximity sensor, radar, lidar, an optical sensor, an infrared sensor, and a camera.

14. The material handling vehicle of claim 10, wherein the processor and memory are configured to detect and determine distances from the object sensor to multiple objects simultaneously.

15. The material handling vehicle of claim 10, wherein the processor and memory are configured to issue the deceleration limit command to the motor based on a determination as to whether
the speed exceeds a speed threshold, and
the weight exceeds a weight threshold.

16. The material handling vehicle of claim 10, wherein the processor and memory are configured to issue the deceleration limit command at one of a plurality of limit levels according to a corresponding plurality of weight thresholds.

17. The material handling vehicle of claim 16, wherein when the weight is between a first weight threshold and a second weight threshold greater than the first weight threshold, the processor and memory are configured to issue the deceleration limit command at the limit level corresponding to the first weight threshold.

18. The material handling vehicle of claim 16, wherein deceleration limit values corresponding to the deceleration limit command decrease as the weight thresholds increase.

19. The material handling vehicle of claim 10, further comprising
a carriage assembly; and
a height sensor configured to sense a height of the carriage assembly,
wherein in the processor and memory are configured to issue the deceleration limit command to the motor further based on the sensed height of the carriage assembly.

20. The material handling vehicle of claim 10, wherein the deceleration limit command includes one or more of disabling and ignoring signals from an accelerator pedal.
